(19) United States
(12) Patent Application Publication
(10) Pub. No.: US 2011/0081866 A1
(43) Pub. Date: Apr. 7, 2011

(54) SERVER MATE

(76) Inventor: BRIAN FICK, Bourbonnais, IL (US)

(21) Appl. No.: 12/572,305

(22) Filed: Oct. 2, 2009

(51) Int. Cl. H04B 7/00; G06Q 50/00; G06F 3/041

(52) U.S. Cl. 455/66.1; 705/15; 345/173

(57) ABSTRACT

The present invention is a system that can be utilized in order for patrons of a restaurant, bar, coffee shop or other establishment to gain the attention of their server so they may make a request. This unique product can assist waiters and waitresses in being more attentive to their tables. This innovative item is also ideal in helping customers feel more satisfied with the service they are receiving. The present invention may be embodied in an arrangement of components that work together to give wait staffs a way to be more attentive to patrons. One component is to be used by customers. A paging device is used by the server. It may also have a touch-screen with a list of requests from first to last. It may list the table number, the request and the time it was placed.

### CROSS REFERENCE TO RELATED APPLICATION

This patent application is related to and claims priority from U.S. Provisional Patent Application Ser. No. 61/101,707 filed Oct. 2, 2008.

### FIELD OF THE INVENTION

This invention generally pertains to restaurant ordering systems. More specifically, the present invention relates to a wireless restaurant ordering system for direct communication between a server and the server's customers.

### BACKGROUND OF THE INVENTION

The invention is particularly applicable to restaurant ordering systems and will be described with particular reference thereto. However, it will be appreciated by those skilled in the art that the invention has broader applications and may also be adapted for use in bars, pubs, taverns, coffee shops, hotels and the like.

Many times servers can become overwhelmed by the amount of customers or requests he or she is experiencing. One can easily forget a table's request during this hectic time. Customers may feel neglected by a server that does not often come back to check on them. A server may not intentionally ignore tables, but it may seem that way to patrons. Having a simple way for customers and servers to be in constant communication may assist both in having a more pleasant experience.

Accordingly, it has been considered desirable to develop a new and improved restaurant ordering system which would overcome the foregoing difficulties and others while providing better and more advantageous overall results

### SUMMARY OF THE INVENTION

The present invention is a system that can be utilized in order for patrons of a restaurant, bar, coffee shop or other establishment to gain the attention of their server so they may make a request. This unique product can assist waiters and waitresses in being more attentive to their tables. This innovative item is also ideal in helping customers feel more satisfied with the service they are receiving.

The present invention maybe embodied in an arrangement of components that work together to give wait staffs a way to be more attentive to patrons. One component is to be used by customers. This preferably waterproof item may be positioned on a table and is a small touch-screen device that has a selection of quick notes on it, which may include order now, drink refills, straws and napkins, silverware, clean up, check, please, question and special request. A stylus may be used to make selections. There may also be the option to have customers type in a special request under a word or letter limit. The paging device the server has may be able to hook conveniently to their belt or pocket. It may also have a touch-screen with a list of requests from first to last. It may list the table number, the request and the time it was placed. The server may have the ability to delete each request as it is filled. Servers may carry an interactive swipe card along with their pager. When the table is sat, the greeter may swipe their card. This will register what time the table is sat. When the server arrives, they may also swipe their card. The server will take meal orders in the same manner as normal. When the table needs something, such as a refill or condiment, they will select the appropriate category on the display on the display screen. This will then be wirelessly transmitted to the server's paging unit. There may be approximately ten categories for users to choose from. Some, such as condiments and drinks, may have drop-down menus to further clarify their request. If a request is made three times in a row, a message may be sent to a device held by a manager.

This product may also have a one-minute or other time requirement in between accepting requests. This allows time for the server to meet the request. The tabletop device may measure approximately 6″ long and wide. This product may be powered by plugging into an electrical outlet or a rechargeable battery. The exact dimensions, materials used for construction and method of operation of present invention may vary upon manufacturing.

### OBJECTS OF THE INVENTION

It is, therefore, one of the primary objects of the present invention to provide a communication system so that customers and servers can be in direct communication.

Another object of the present invention is to provide a communication system so that customers may pick from a list of predetermined requests to be communicated to their respective server.

Still another object of the present invention is to provide a system that will allow servers to be more attentive to their customers.

In one embodiment the invention is a customer to server communication system comprising: a first wireless communications device with a predetermined list of requests related to a food or beverage service; a second wireless communications device for receiving a request from said predetermined list of requests related to a food or beverage service; wherein said first wireless communication device directly transmits said request from said predetermined list of requests related to a food or beverage service to said second wireless communications device for receiving a request from said predetermined list of requests related to a food or beverage service. In another embodiment said predetermined list of requests related to a food or beverage service comprises at least one request selected from a group consisting of a request for napkins, a request for utensils, a request for beverage refill and a request for a bill. In still another embodiment said first wireless communication device comprises a touch screen interface. In yet another embodiment said second wireless communication device comprises a touch screen interface. In another embodiment said first wireless communication device receives power via a universal serial bus cable. In yet still another embodiment said first wireless communication device comprises a smart phone. In yet another embodiment said second wireless communication device comprises a smart phone. In still another embodiment said first wireless communication device is a waterproof device. In still another embodiment said second wireless communication device is a waterproof device. In yet another embodiment said first wireless communication device is a waterproof device, and said second wireless communication device is a waterproof device.

In another embodiment the invention is a customer to server communication system comprising: a first waterproof wireless communications device with a predetermined list of requests related to a food or beverage service; a second waterproof wireless communications device for receiving a request from said predetermined list of requests related to a food or beverage service; a touch screen interface; wherein said first wireless communication device directly transmits said request from said predetermined list of requests related to a food or beverage service to said second wireless communications device for receiving a request from said predetermined list of requests related to a food or beverage service. In yet another embodiment said predetermined list of requests related to a food or beverage service comprises at least one request selected from a group consisting of a request for napkins, a request for utensils, a request for beverage refill and a request for a bill. In still another embodiment said first waterproof wireless communication device receives power via a universal serial bus cable. In yet still another embodiment said first waterproof wireless communication device comprises a smart phone. In yet another embodiment said second waterproof wireless communication device comprises a smart phone. In still yet another embodiment said first wireless communication device comprises a smart phone, and said second wireless communication device comprises a smart phone.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general perspective view of several components of a preferred embodiment of the present invention.

FIG. 2 is a close up perspective view of several components of a preferred embodiment of the present invention.

FIG. 3 is a general perspective view of a preferred embodiment of the present invention being used in a restaurant setting

FIG. 4 is a close up perspective view of a customer using the table top device of the present invention.

FIG. 5 is a close up perspective view of a server using the pager device of the present invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

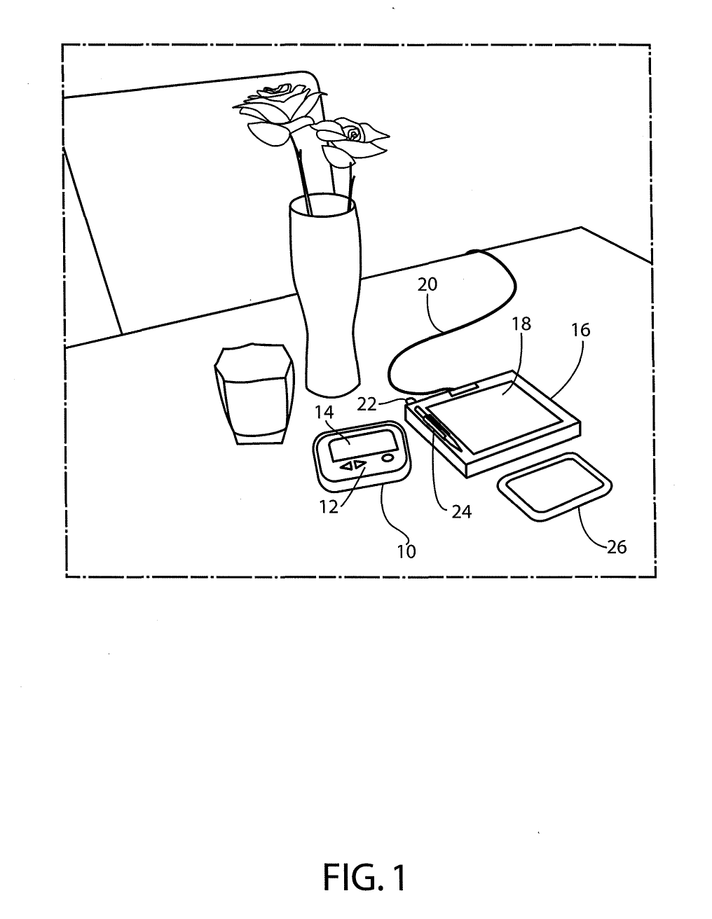

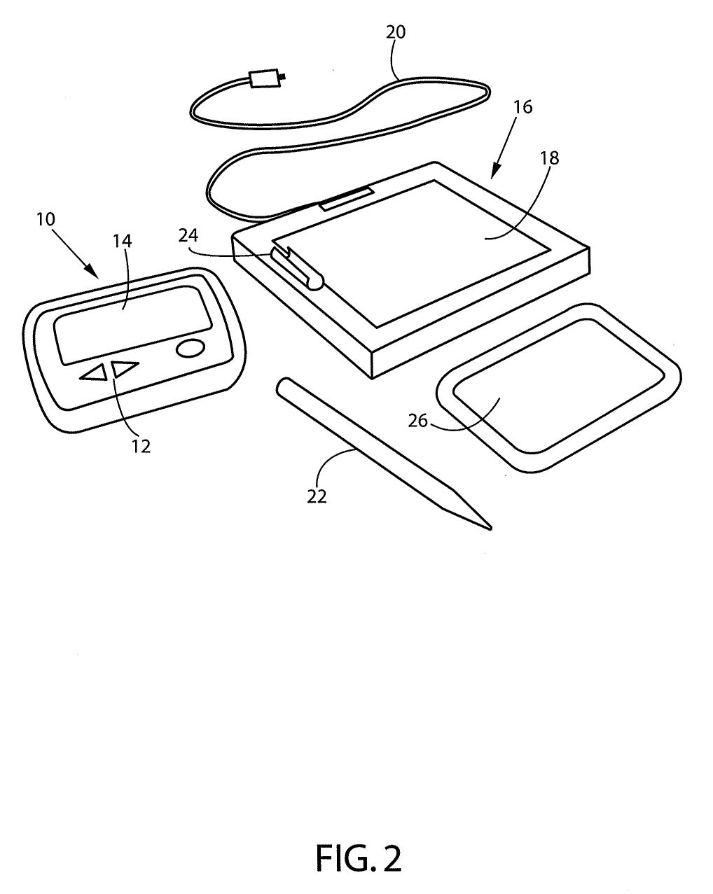

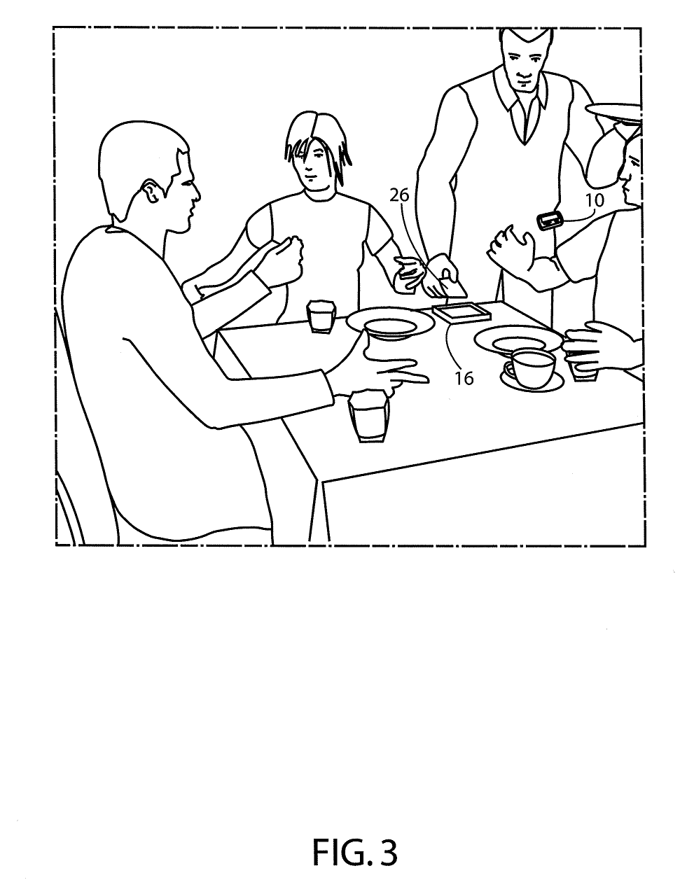

Reference is now made to FIGS. 1 through 5 which show several views of the present invention. The current embodiment of the present invention comprises pager device 10 with server interface 12 for operating the pager device 10 and pager display 14. The current embodiment also comprises tabletop device 16 with touch screen interface 18, optional power cord 20, optional stylus 22 and optional stylus holder 24.

The pager device 10 or the tabletop device 16 maybe replaced by or used with a mobile phone or smart phone 26. That is a customer may be able to use their smart phone navigate the same menus as would be available on the tabletop device 16. Also, the server may use a smart phone 26 as a pager device 10.

Both pager display 14 and touch screen interface 18 are preferably touch screen interfaces, but could use traditional button controls as well.

Optional power cord 20 could be any type of power cord known in the art but preferably is a USB cord capable of power and date transfer. It is also envisioned that tabletop device 16 could be completely mobile by using an internal or external battery.

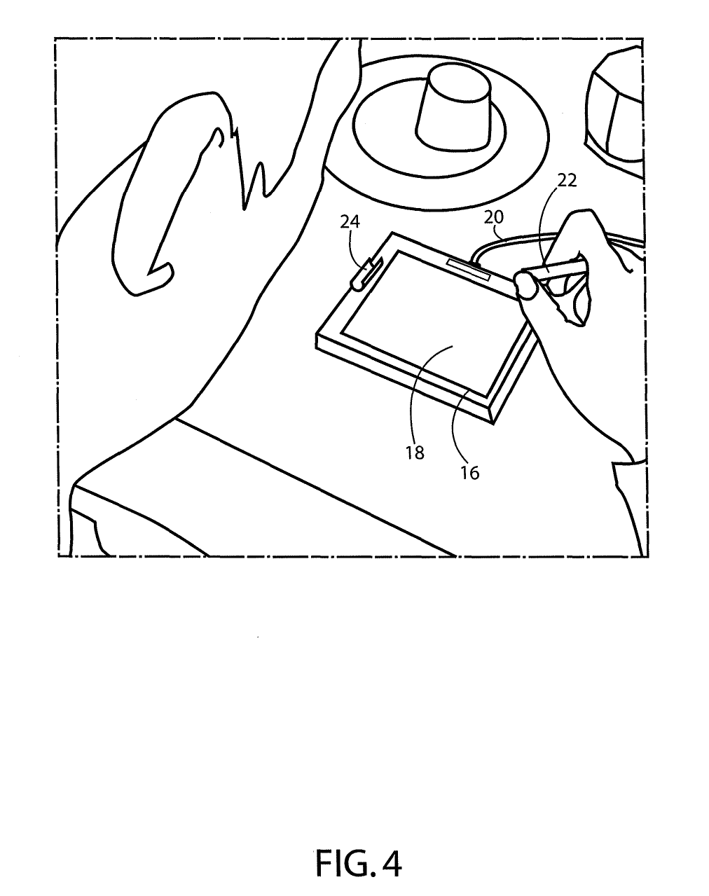

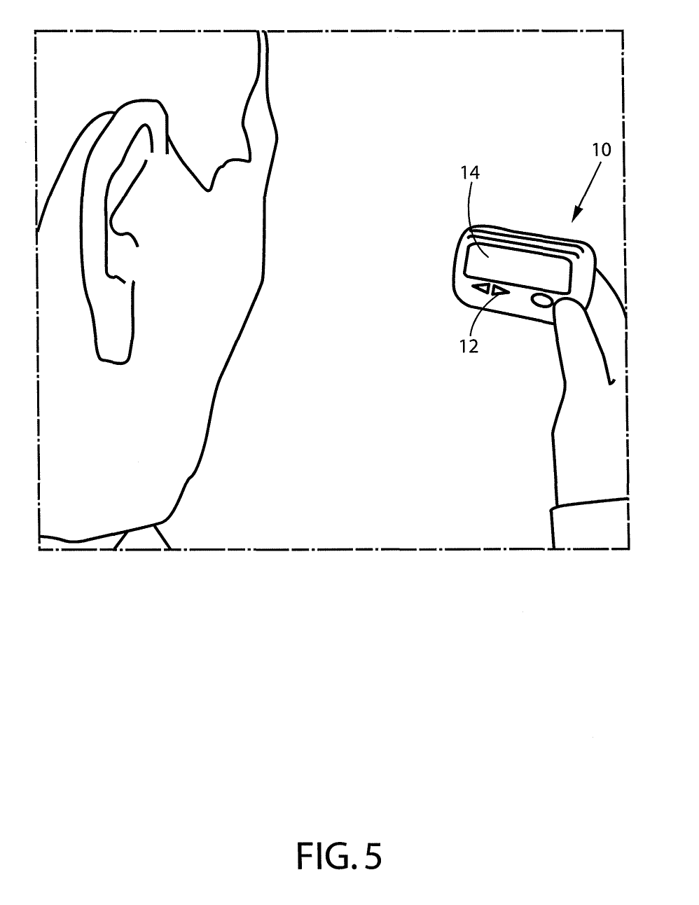

Reference is now made more particularly to FIGS. 4 and 5, which show close up views of possible menu options and telecommunicated messages. Tabletop device 16 by means of touch screen interface 18 will allow for the selection of quick requests, which may include order now, drink refills, straws and napkins, silverware, clean up, check please, question and special requests. A stylus 22 may be used to make selections. There may also be the option to have customers manually type in a special request under a word or letter limit. The pager device 10 will then communicate these requests to the server instantly.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A customer to server communication system comprising:
a first wireless communications device with a predetermined list of requests related to a food or beverage service;
a second wireless communications device for receiving a request from said predetermined list of requests related to a food or beverage service;
wherein said first wireless communication device directly transmits said request from said predetermined list of requests related to a food or beverage service to said second wireless communications device for receiving a request from said predetermined list of requests related to a food or beverage service.

2. A customer to server communication system as claimed in claim 1, wherein said predetermined list of requests related to a food or beverage service comprises at least one request selected from a group consisting of a request for napkins, a request for utensils, a request for beverage refill and a request for a bill.

3. A customer to server communication system as claimed in claim 1, wherein said first wireless communication device comprises a touch screen interface.

4. A customer to server communication system as claimed in claim 1, wherein said second wireless communication device comprises a touch screen interface.

5. A customer to server communication system as claimed in claim 1, wherein said first wireless communication device receives power via a universal serial bus cable.

6. A customer to server communication system as claimed in claim 1, wherein said first wireless communication device comprises a smart phone.

7. A customer to server communication system as claimed in claim 1, wherein said second wireless communication device comprises a smart phone.

8. A customer to server communication system as claimed in claim 1, wherein said first wireless communication device is a waterproof device.

9. A customer to server communication system as claimed in claim 1, wherein said second wireless communication device is a waterproof device.

10. A customer to server communication system as claimed in claim 1, wherein said first wireless communication device is a waterproof device, and said second wireless communication device is a waterproof device.

11. A customer to server communication system comprising:
a first waterproof wireless communications device with a predetermined list of requests related to a food or beverage service;
a second waterproof wireless communications device for receiving a request from said predetermined list of requests related to a food or beverage service;
a touch screen interface;
wherein said first wireless communication device directly transmits said request from said predetermined list of requests related to a food or beverage service to said second wireless communications device for receiving a request from said predetermined list of requests related to a food or beverage service.

12. A customer to server communication system as claimed in claim 11, wherein said predetermined list of requests related to a food or beverage service comprises at least one request selected from a group consisting of a request for napkins, a request for utensils, a request for beverage refill and a request for a bill.

13. A customer to server communication system as claimed in claim 11, wherein said first waterproof wireless communication device receives power via a universal serial bus cable.

14. A customer to server communication system as claimed in claim 11, wherein said first waterproof wireless communication device comprises a smart phone.

15. A customer to server communication system as claimed in claim 11, wherein said second waterproof wireless communication device comprises a smart phone.

16. A customer to server communication system as claimed in claim 11, wherein said first wireless communication device comprises a smart phone, and said second wireless communication device comprises a smart phone.
